(19) United States
(12) Patent Application Publication
(10) Pub. No.: US 2008/0138474 A1
(43) Pub. Date: Jun. 12, 2008

(54) HEATABLE PACKAGE WITH MULTI-PURPOSE VALVE AND METHOD OF MANUFACTURE

(75) Inventor: R. C. Murray, Lakewood Ranch, FL (US)

Correspondence Address: GIFFORD, KRASS, SPRINKLE,ANDERSON & CITKOWSKI, P.C, PO BOX 7021, TROY, MI, 48007-7021, US

(73) Assignee: Pouch Pac Innovations, LLC, Sarasota, FL (US)

(21) Appl. No.: 12/031,803

(22) Filed: Feb. 15, 2008

Related U.S. Application Data
(63) Continuation-in-part of application No. 11/329,712, filed on Jan. 11, 2006.
Application No. 11/329,712 is a continuation-in-part of application No. 10/228,430, filed on Aug. 27, 2002, now abandoned.
(60) Provisional application No. 60/315,207, filed on Aug. 27, 2001.

(51) Int. Cl. B65D 81/34; B65D 33/01; B01D 53/22; B65D 30/22

(52) U.S. Cl. 426/118; 383/103; 426/113; 95/45

(57) ABSTRACT

A package for a product having a multi-purpose valve includes a valve having a tubular body that defines a recess between open and closed ends, and the closed end includes an aperture for venting a pressurized gases therethrough. A retaining member operative for snap-fit engagement with the tubular body is spaced from the closed end of the tubular body. A breathable membrane element is positioned between the tubular body closed end tubular body and the retaining member. The breathable membrane element is positioned adjacent the closed end for respiring a gas from the product through the membrane to maintain a predetermined a concentration of oxygen and a predetermined concentration of carbon dioxide within the package. The membrane element is displaceable from the closed end to allow pressurized gases to pass through the closed end aperture during heating of the package.

### RELATED APPLICATIONS

This application is a continuation-in-part of U.S. patent application Ser. No. 11/329,712 filed Jan. 11, 2006, which is a continuation-in-part of U.S. patent application Ser. No. 10/228,430 filed Aug. 27, 2002, which claims priority of U.S. Provisional Patent Application Ser. No. 60/315,207 filed Aug. 27, 2001. All are incorporated herein by reference.

### FIELD OF THE INVENTION

The present invention relates generally to a package for both storing and cooking a food product contained therein, and more particularly to a package having a multi-purpose valve with a breathable membrane, and a method of manufacturing and filling the package.

### BACKGROUND OF THE INVENTION

Various types of disposable, portable packages are known in the art for storing a fluid or dry product, such as a liquid, granular material, powder or the like. One example of such a package is a flexible pouch. Consumers prefer the convenience of flexible pouches, due to their shape, size and shelf life. Flexible pouches have been used for some time to distribute beverages, such as fruit juice and the like. More recently, flexible pouches have been utilized for solid food products. Another example of a disposable package is a container covered by a film.

At the same time, various types of disposable packages have been developed for use in heating or cooking foods in an oven, including a conventional electric or gas oven, a convection oven or a microwave oven. A common feature of the disposable package is a venting means, which provides for the release of steam or any other gas that may be generated within the package. The package may be used for both storing and cooking the food product contained therein. The package may be stored frozen, refrigerated, or at room temperature. Advantageously, the package may also be used in cooking a frozen food, or a food at room temperature.

While containers with a vent valve also work well both for storing and heating the food product contained therein, certain food products may also respire during storage. Thus, there is a need in the art for a package with a multi-purpose valve that vents when the package is heated, and respires during storage to maintain a predetermined concentration of oxygen and carbon dioxide in the package during storage.

### SUMMARY OF THE INVENTION

Accordingly, a package for packaging a product contained therein and preparing the product by heating includes a multi-purpose valve assembly. The valve assembly includes a tubular body having an open end and a closed end that defines a recess between the open and closed ends, and the closed end includes an aperture for venting a pressurized gas therethrough. A retaining member operative for snap-fit engagement with the tubular body is spaced apart from the closed end of the tubular body. A breathable membrane element having a plurality of apertures is positioned between the closed end of the tubular body and the retaining member, such that the breathable membrane element respires a gas from the product through the plurality of apertures in the membrane element at a predetermined transmission rate, to maintain a predetermined concentration of oxygen and a predetermined concentration of carbon dioxide within the package during storage of the pouch. The membrane element is displaceable from the closed end to vent a pressurized gas through the closed end aperture during heating of the package above a predetermined threshold temperature.

One advantage of the present invention is that a package with a multi-purpose valve and an improved method of making and filling a package with a product is provided, and the package is suitable for both storing and heating of the product contained therein. Another advantage of the present invention is that a package with a multi-purpose valve and method of making the same is provided that includes a multi-purpose valve having an integral breathable membrane element. A further advantage of the present invention is that a package with a multi-purpose valve and a method of making the same is provided that is cost effective to manufacture. Yet a further advantage of the present invention is that the package can be placed unopened in a microwave oven in order to heat the contents. Yet still a further advantage of the present invention is that the package can be frozen, refrigerated, or at room temperature, and then placed unopened in a microwave oven in order to heat the contents of the package. Still another advantage of the present invention is that the breathable membrane element allows oxygen and carbon dioxide transmission during storage, to enhance product quality.

### BRIEF DESCRIPTION OF THE DRAWINGS

FIG. 1 is a front view of a flexible pouch with a multi-purpose valve, according to the present invention.

FIG. 2 is a side view of the flexible pouch of FIG. 1, according to the present invention.

FIG. 3 is a front view of the flexible pouch of FIG. 1 partially separated along the line of weakening, according to the present invention.

FIG. 4 is a perspective view of the flexible pouch of FIG. 1, after the top portion has been removed, according to the present invention.

FIG. 5 is a front view of another example of the flexible pouch, according to the present invention.

FIG. 6 is a front view of the flexible pouch of FIG. 5, according to the present invention.

FIG. 7 is a perspective view of another embodiment of a package according to the present invention.

FIG. 8 is a flowchart illustrating a method of using the flexible pouch, according to the present invention.

FIG. 9 is a perspective view of another example of a flexible pouch with a frangible seal, according to the present invention.

FIG. 10 is a perspective view of yet another example of a flexible pouch that includes a breathable patch, according to the present invention.

FIG. 11 is a flowchart illustrating a method of manufacturing and filling the flexible pouch, according to the present invention.

FIG. 12 is a top elevational view of the multi-purpose valve, according to the present invention.

FIG. 13 is a cross-sectional view of the valve of FIG. 12, according to the present invention.

FIG. 14 is a top elevational view of the valve body, for the valve of FIG. 12, according to the present invention.

FIG. 15 is a side view of the valve body for the valve of FIG. 12, according to the present invention.

FIG. 16 is a cross-sectional view of the valve body for the valve of FIG. 12, according to the invention.

FIG. 17 is an elevational view of a breathable membrane element for the valve of FIG. 12, according to the present invention.

FIG. 18 is a view of a retaining member for the valve of FIG. 12, according to the present invention.

FIG. 19 is a side view of the retaining member for the valve of FIG. 12, according to the present invention.

### DETAILED DESCRIPTION OF THE PREFERRED EMBODIMENTS

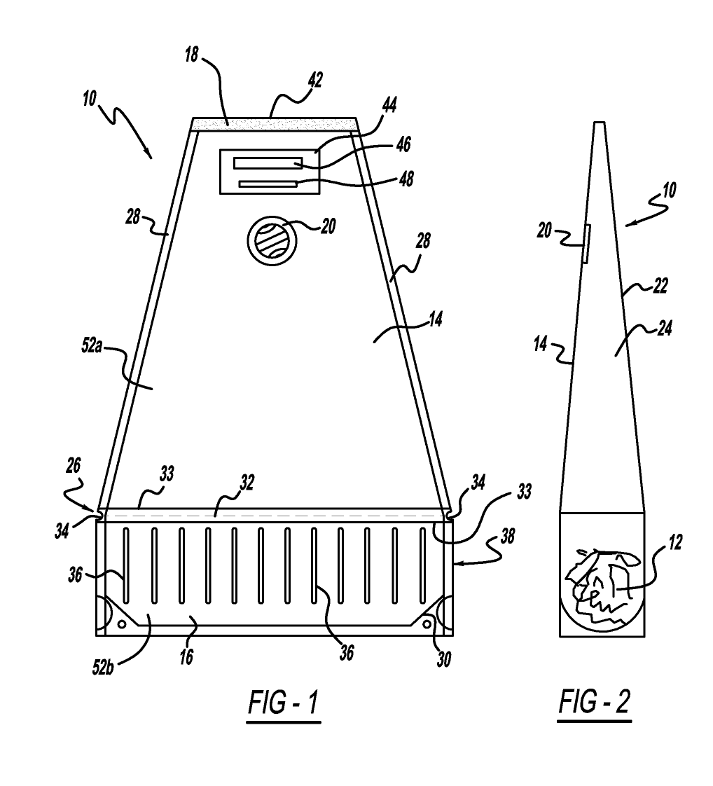

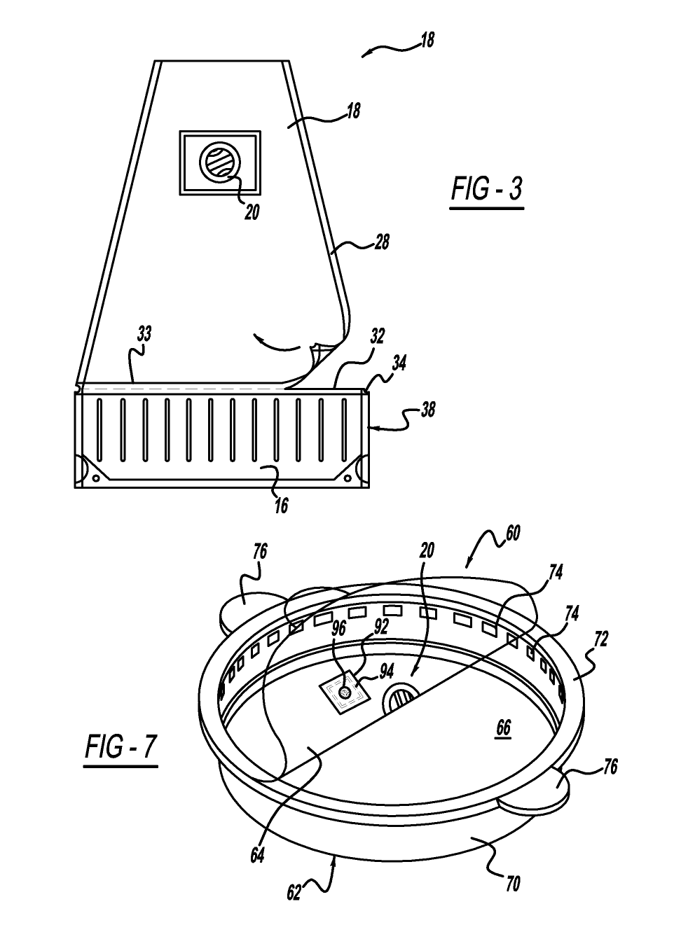

A package for both storing and cooking a food product is provided. The package may be a flexible pouch, or a sealed tray used to contain a product. Referring to FIGS. 1-6 and 9-10, an example of a sealed, flexible pouch 10 is illustrated. The pouch 10 is filled with a product (not shown) and sealed. The type of product is unlimited, and could have a solid or a liquid form. The product is preferably a food item and the pouch may contain a single serving, or multiple servings, of the food product. In an example, the pouch 10 is a flexible stand-up pouch suitable for heating a precooked food portion 12 in an oven, such as a microwave oven, or convection oven or the like. In another example, a fresh food portion could also be contained by the flexible pouch.

The flexible pouch 10 is preferably formed from a roll of flexible, preprinted laminate material. The choice of laminate material is nonlimiting, and is influenced by factors such as the product contained in the pouch 10, the shape of the pouch or the anticipated use of the pouch. The laminate is typically a three or four or five or more gauge material. The outer layer is usually preprinted and may be a shrink sleeve or label or the like. Alternatively, at least a portion of the material may not be printed, i.e. translucent, in order to view the contents contained therein. The clear portion could be in a gusset or insert. For example, the laminate material may include at least one layer of virgin polyethylene terephthalate (PET) and at least one layer of aluminum foil (AL) and another layer such as EVOH, PET, polyethylene, or polypropylene or nylon or the like. Alternatively, the laminate may include a metalized foil paper layer laminated to a cast polypropylene layer and another layer of PET, polyethylene or EVOH. Another material example includes a cast polypropylene (CPP) layer, a polyethylene (PET) layer, a foil (AL) layer, a nylon (ONO) layer and another CPP layer. Another example of a material structure is the use of nylon, foil, nylon, and cast polypropylene (ONO/AL/ONO/CPP) or CPP/NY/AL/CPP. Another example of a material structure is ONO/AL/COEX-ONO-LDPE. A further example of a laminate material structure is CPP/AL/ONO/PE. This structure works well when the product has a short shelf life, and the nylon eliminates stretching or cracking of the AL layer. Advantageously, a pouch 10 made using the cast polypropylene laminate material retains its filled shape even as the product is removed from the pouch 10. It should be appreciated that a portion of the material may be a clear laminate, in order to view the contents of the pouch.

The pouch 10 may be formed from a sheet of material or panel that is folded so that the edges are joined together to form a seam. Alternatively, the pouch may be formed from two facing panels of material that are joined together along corresponding edges. The pouch 10 includes a front wall 14 and a rear wall 22. In this example, the pouch 10 has a generally rectangular shape, although other shapes such as round, cylindrical, or the like are contemplated. Further, the body of the pouch is defined by an upper edge 18, an opposed lower edge 16, and a side edge 28 extending therebetween the upper and lower edges 16, 18.

The pouch 10 may include a sidewall 24 disposed between the front and rear walls 14, 22. The sidewall 24 advantageously allows the pouch 10 to acquire another shape, such as cylindrical, or pyramidal, or the like, or to stand upright. For example, the sidewall 24 may be formed as a gusset, pleat or an insert. The gusset may be generally wider at the lower edge and taper upwardly towards the upper edge, or be of a uniform dimension. The sidewall 24 may be integrally formed in the panel or a separate piece of material. Alternatively, the sidewall may be formed at the lower edges of the pouch 10 to provide a base for the pouch 10 to stand upright.

The pouch may include a plurality of vertically oriented ribs 36. The ribs provide rigidity to the panel. In this example, the ribs are thermoformed into the wall of the lower compartment of the pouch, so that the lower compartment forms a tray 38 with sides 40 for serving the product after the upper compartment is removed.

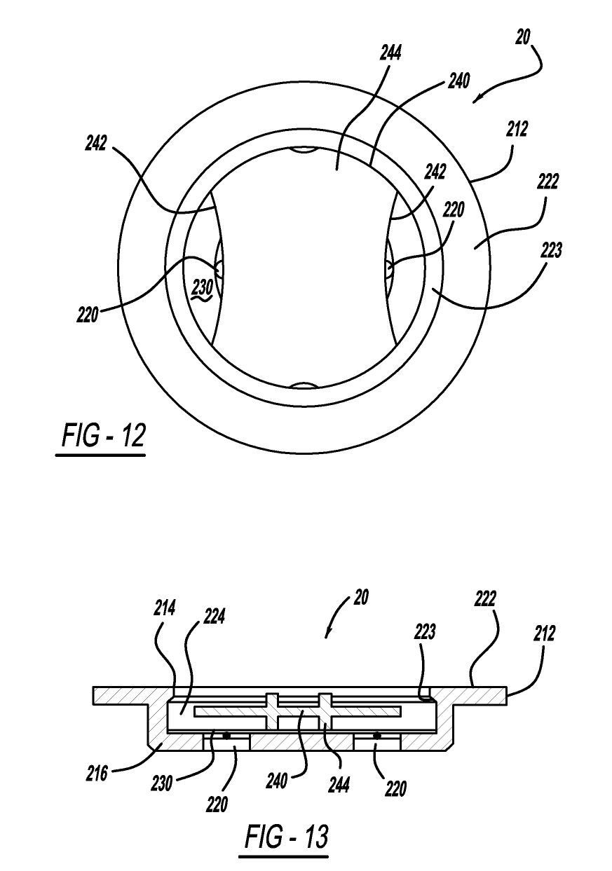

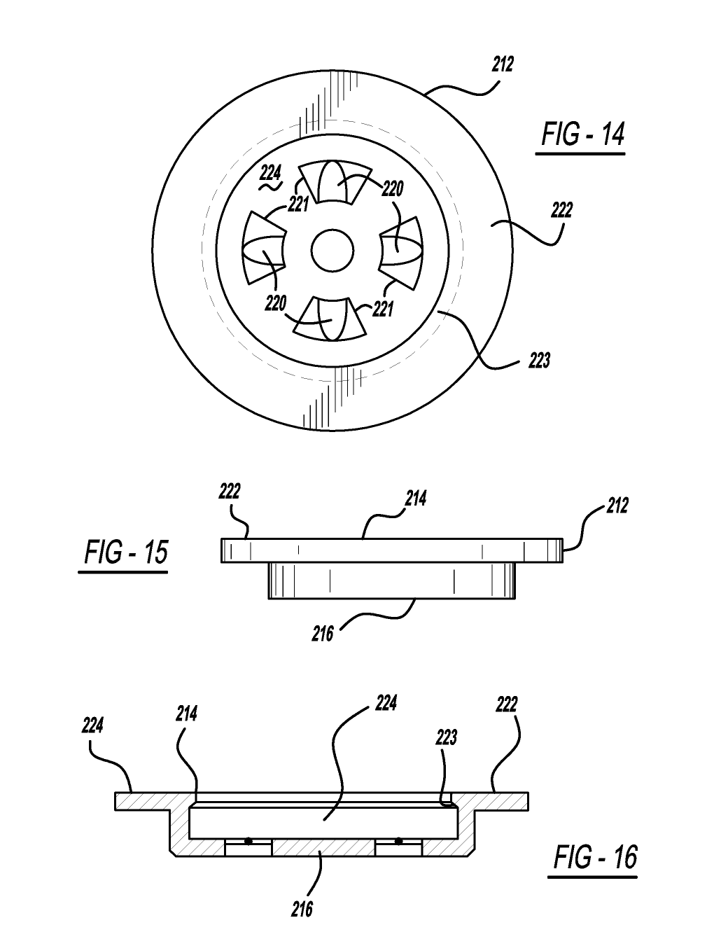

The pouch includes an integral valve 20 as further shown in FIGS. 12-19. The valve 20 is preferably positioned in one wall of the pouch 10, such as the front wall 14 of this example. The valve 20 may be welded in an aperture formed in the panel during the flexible pouch forming process. The valve 20 functions to exhaust gas, such as steam, formed within the package while cooking and to respire during storage. During heating of the pouch, the valve remains tightly closed, until pressure from the gas, such as steam, reaches a predetermined pressure value. An example of a predetermined pressure is approximately 3 mbar. The valve 20 opens and remains open, to release the gas from the package in a controlled manner. The valve 20 may also respire during storage to maintain a predetermined level of oxygen and carbon dioxide in the package. The additional oxygen counteracts gas formed in the package for other reasons, such as gas formed by decaying food or during freezing or the like.

The valve 20 includes a tubular body 212 having an open end 214 and a closed end 216. The tubular body 212 is made from a material, such as cast polypropylene or the like. The closed end 216 includes at least one aperture 220 for venting pressurized gas and/or steam, as described in greater detail below. A sector-shaped recess 221 corresponding to the aperture 220 is formed in the closed end 216, and the aperture 220 is formed at a bottom surface of the recess 221. In this example, four petal-shaped apertures 220 are formed in the closed end 216 of the body 212, each being positioned within its own respective recess 221, with each aperture 220 having a collective area ranging between 12-24 mm². In another example, each aperture 220 has an approximate width of 1.8 mm and approximate length of 2.6 mm. The number, shape, and size of the apertures 220 is selected to permit the pressure to be exhausted at a predetermined rate. The body 212 can have any suitable cross-sectional shape, such as square, oval, octagonal, and triangular. In this example, the body 212 has a circular cross-sectional shape.

A flanged portion 222 is defined along the open end 214 of the body 212. The flanged portion 222 is annular and extends radially outwardly from the open end 214. The flanged portion 222 is also concentric with the body 212. The flanged portion 222 includes an inside edge defining a rim 223. The rim 223 has a diameter less than that of the body 212. A recessed portion 224 is defined by the walls of the body 212 and has a depth defined between the rim 223 of the flanged portion 222 and the closed end 216.

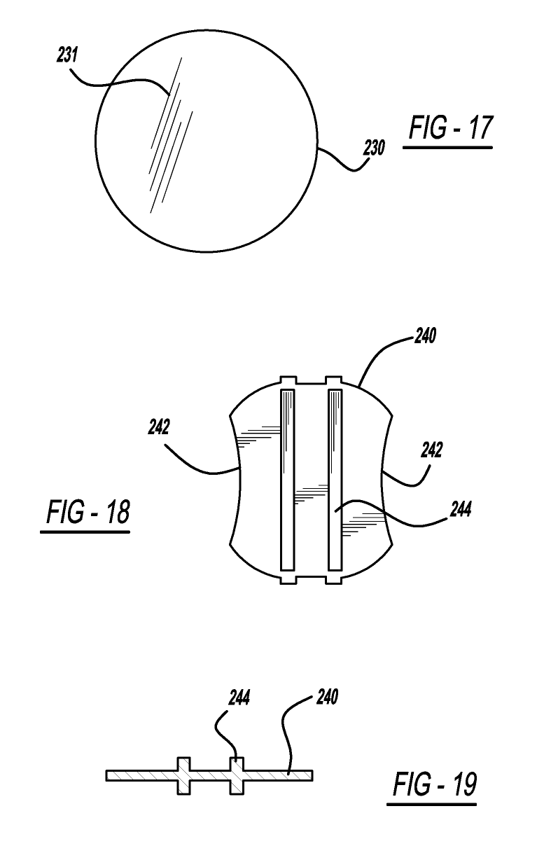

The release valve assembly 210 also includes a breathable membrane element 230, as shown in FIG. 17. The membrane element 230 is operative to be received and seated into the recessed portion 224 of the body 212. More specifically, the membrane element 230 seats adjacent the closed end 216 of the body 212. The membrane element 230 is made from a microporous material having a predetermined number of apertures 231 arranged in a predetermined manner to transfer gas into and out of the pouch through the membrane element to maintain a predetermined concentration of oxygen and carbon dioxide in the package. The size, shape, number, and location of apertures 231 is selectively determined by factors such as desired respiration rate, or the product contained therein. The aperture 231 may be a perforation formed using a cutting device, such as a laser. Respiring biological materials, such as fresh-cut fruit and vegetables, consume oxygen and produce carbon dioxide at rates dependent upon temperature and the stage of their development. The storage capability of the product within the package depends on the relative and absolute concentrations of O₂ and CO₂ in the atmosphere surrounding the product, and on temperature. The breathable membrane element is made from a film of polypropylene or cast propylene or the like. An example of breathable film is made by Landec Corporation. The incorporation of a breathable membrane element 231 in the valve 30 advantageously allows for the transfer of air during storage of the product, in order to produce an atmosphere within the package having optimal O₂ and CO₂ concentrations for preserving the particular product. The membrane element 230 respires according to predetermined combinations of O₂ permeability and change in O₂ permeability, with temperature and ratio of CO₂ permeability to O₂ permeability. In this way, the valve 20 advantageously releases steam during heating and also respires during storage. In an example, the membrane element 230 has a thickness between 25-70 microns and a corresponding oxygen transmission rate ranging between 1200 to 1600 cc/square meter/24 hours.

The release valve assembly 10 also includes a retaining member 240. The retaining member 240 is operative to be received in the recessed portion 224 of the body 212 in snap-fit engagement with the rim 223 of the flanged portion 222. The retaining member 240 is disc-shaped and has a side having at least one rib 244 protruding outwardly therefrom. A portion of the membrane 230 is held between the rib 244 and the closed end 216 while the retaining member 240 is engaged with the rim 223. The remainder of the membrane 230 remains deformable and displaceable from the closed end 216 by gases vented through the apertures 220.

The retaining member 240 has at least one concave edge 242. The concave edge 242 facilitates removal of the retaining member 240 from the recessed portion 224, by allowing an instrument such as a fingernail or other similarly shaped instrument, to pry the concave edge 242 up from and out of the recessed portion 224 of the body 212.

The release valve assembly 20 is used with packaging containing various types of food items including heatable items. Below a threshold temperature range of 130-180° C. or pressure range of less than 4-7.5 mbars the membrane element 230 remains flat and is seated adjacent the closed end 216 substantially sealing the apertures 220. At the same time, the membrane element 230 allows the package to “breathe” by allowing two-way transmission of oxygen and carbon dioxide gases through the plurality of apertures 231, depending on the oxygen and carbon dioxide concentration within the package. When the packaging is heated above the threshold temperature range or the pressure exceeds the threshold valve opening pressure, the gases deform or displace at least a portion of the membrane element 230 from the closed end 216 allowing gas to vent through the apertures 220. After the pressure within the packaging has equalized with ambient air, the membrane element 230 returns to its start position adjacent the closed end 216. The membrane 230 provides for the intake of oxygen into the package during storage of the package at temperatures below the threshold valve opening temperature.

It should be appreciated that the pouch 10 may include other components or features, as is known in the art. For example, the valve 20 may be completely enclosed by a frangible seal 25 formed in the walls of the pouch. The frangible seal 25 is designed to burst when subjected to a predetermined frangible seal bursting pressure. The frangible seal 25 advantageously isolates the valve 20 from the contents of the pouch. An example of a pouch with a frangible seal is disclosed in commonly assigned U.S. patent application Ser. No. 11/329,712, which is incorporated herein by reference.

In another example, the flexible pouch 10 may advantageously include a guide pocket 27 formed in a panel or wall of the pouch 10 prior to filling and sealing, to facilitate the separation of the front and rear panels prior to the filling of the pouch 10. An example of a pouch with a guide pocket is disclosed in commonly assigned U.S. patent application Ser. No. 10/310,221.

Another example of a component or feature is an opening means 26 for accessing the contents of the pouch. Various types of opening means are known in the art for this purpose. An example of an opening means 26 for accessing the contents or dispensing the contents from the pouch 10 is a cap secured to a fitment. It should be appreciated that the fitment is usually applied prior to filling the pouch. Another example of an opening means 26 is a straw-pierceable portion for receiving a straw. Still another example of an opening means is a resealable fitment, such as a zipper that is sold under the name TopTite™. A further example of an opening means 26 is a tear-off portion. The tear-off portion usually has an integral tear notch 34 for initiating the tearing. Still a further example of an opening means is a pull tab covering an opening in the pouch.

Still another example of a component or feature is an integrally formed label 44 having a barcode 46. The barcode enables information, such as cooking time and temperature, to be read by a scanner. For example, a microwave scanner may automatically read the label and automatically enter cooking time and temperature into a device, such as the microwave. Alternatively, the label may include a cooking temperature indicator 48, such as a strip of temperature-sensitive material which changes color upon reaching a predetermined temperature, so as to provide an indication that the food is properly heated.

Referring to FIG. 10, a further example of a component or feature is a breathable patch 92 of microporous base film, or an oxygen transmission patch (OTR) incorporated into an opening in the wall of the pouch 10. The breathable patch is similar in structure to the membrane element utilized in the valve, and performs a similar function. As previously discussed, the incorporation of a breathable patch 92 in the package advantageously allows for respiring of gas formed within the package and the intake of oxygen, in order to produce an atmosphere within the package having optimal O₂ and CO₂ concentrations for preserving the particular product. An example of such a patch 92 is similar to the membrane, and is produced by Landec Corporation, and disclosed in U.S. Pat. No. 6,376,032. The patch 92 is produced from a microporous film, which respires according to predetermined combinations of O₂ permeability and change in O₂ permeability, with temperature and ratio of CO₂ permeability to O₂ permeability. These films are typically supplied as a patch having an adhesive strip extending around the periphery to adhere to an edge of the opening in the wall of the pouch. The pouch may be any shape.

The respiration can be controlled by first cutting a hole 96 in the wall of the pouch of a predetermined size, and affixing the breathable patch 92 over the hole. Because different food products, such as fruits, vegetables and meats, have different rates of decomposition, the amount of gas permeability varies depending on the product contained within the package. The hole size formed in the pouch or film may be varied in accordance with the food product contained within the package in order to control the rate of respiration.

A hot melt or pressure adhesive may be used to bond the patch to the film or wall of the pouch. It should be appreciated that the adhesive should be of sufficient adhesive strength to resist pressure generated by steam during a heating operation, such as microwaving. For example, the adhesive may be applied to the patch in a pair of lines as shown at 94, in order to mount the patch 92 to the pouch wall. Steam produced during the heating of the product may eventually break down the first adhesive line or loosen the second adhesive line. The use of the two adhesive lines increases the adhesion of the patch 92 to the lid or pouch during heating.

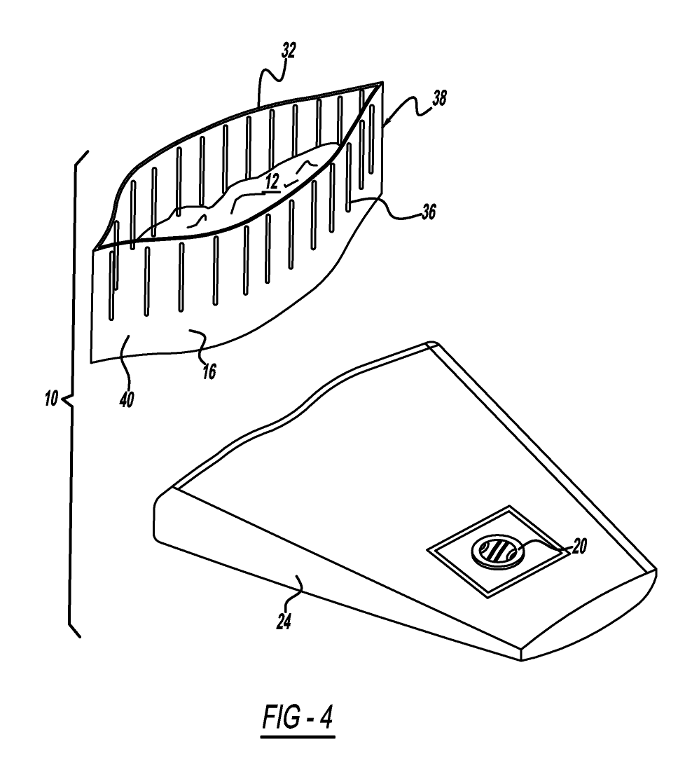

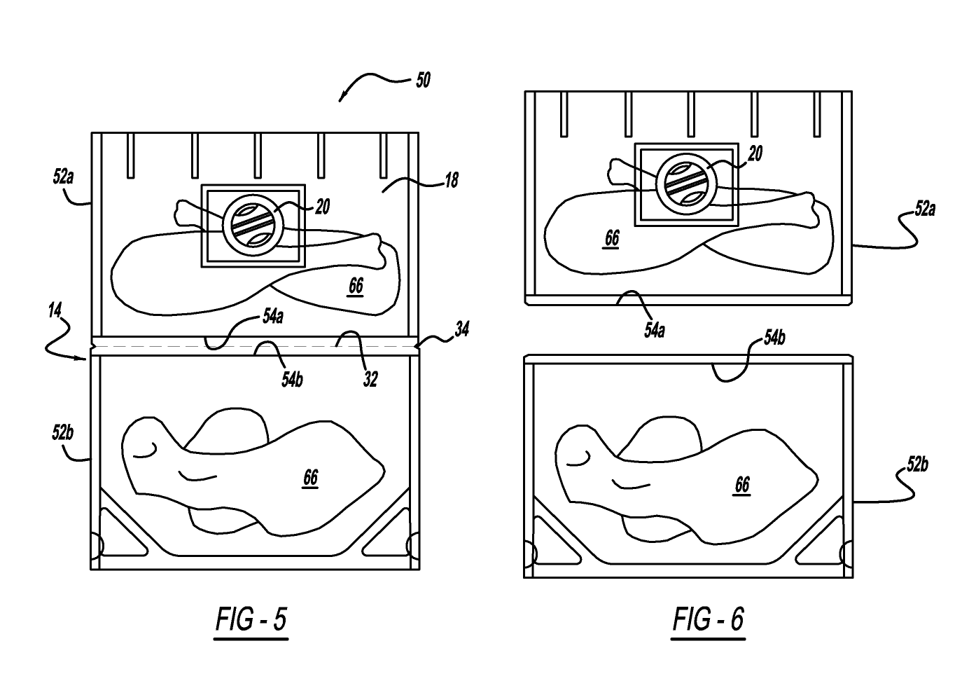

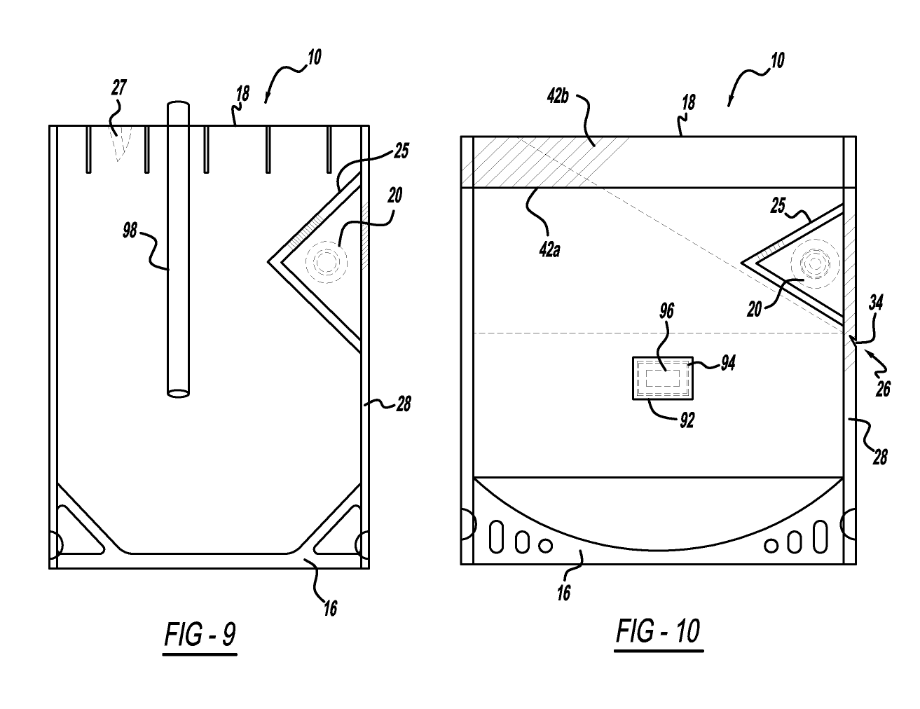

The pouch 10 may form one compartment for the product, as shown in FIGS. 9 and 10. As shown in FIGS. 1-6, the pouch 10 may include multiple discrete compartments. In the example shown in FIGS. 5 and 6, there are two compartments 52a, 52b. In this embodiment, seals are formed on either side of a line of weakening shown at 32, to form the compartments 52a, 52b. It should be appreciated that each compartment may hold a unique product. For example, a first food portion, such as a salad, is filled into the lower compartment 52b of the pouch 50, and a seal 54a, 54b is formed on either side of the line of weakening 32. In this example the seal is a heat seal, although other types of seals could be utilized. Thus, the top of the lower portion is closed by a seal 54b and a bottom of the upper portion is closed by a seal 54a. A second food portion, such as chicken, is then filled into the upper compartment 52a and the upper edges of the upper compartment 52a are then sealed, as previously described. It should be appreciated that one or both of the upper compartment 52a or lower compartment 52b may also include a valve 20 surrounded by a frangible seal 25, to isolate the valve from the product.

In order to prepare the product, the upper compartment 52a is separated from the lower compartment by way of the tear notches 34 and line of weakening 32. By way of example, the upper compartment 52a may be heated, such as in using a microwave oven. After heating the upper compartment 52a of the pouch 50, the seal 52 at the upper edge of the lower compartment 52b is opened to form the tray and provide access to the contents contained therein, which in this example is a salad. In another example, a food product in the upper compartment 52a of the pouch 50 is heated, the bottom seal 54a of the upper compartment 52a is opened and the both products are served from the lower tray, for service as a meal. In another example, two different food products may be placed in the upper and lower compartments 52a, 52b respectively and a second valve is also mounted in the wall of the lower compartment 52b. The second valve may also be surrounded by a frangible seal 25. The upper compartment 52a and lower compartment 52b may be separated and heated separately. In this way, two food types which require different cooking times may be contained within the pouch. Both food portions may be served in the tray, as previously described.

It is contemplated that the pouch may undergo a secondary process after it is filled with the product. For example, the filled pouch may be frozen. Alternatively, the filled pouch may be pasteurized in order to have a stable shelf life at ambient temperature. Examples of pasteurized food products include dairy products such as milk or meat products such as chicken or the like. Further, the pouch may incorporate any of the above-described features in any combination. The finished pouch 10 may assume various shapes, such as cylindrical, cubical, conical or the like, as influenced by the type of product and intended usage of the pouch.

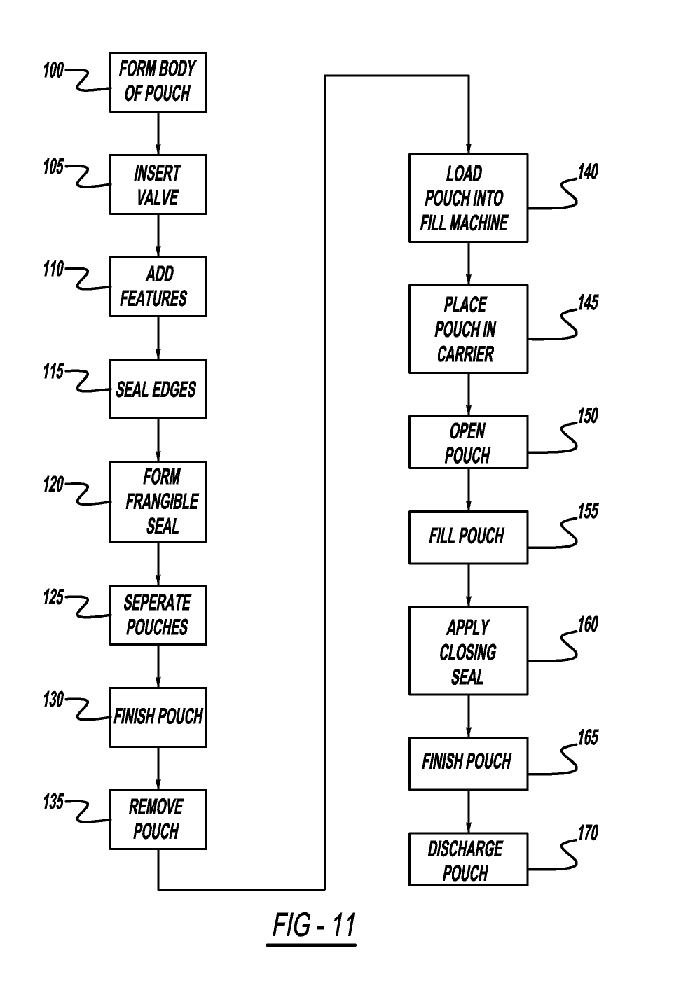

Referring to FIG. 11, a method for forming and filling a package, such as the flexible pouch 10, having a multi-purpose valve, such as that described with respect to the previous figures, is illustrated. The method begins in block 100 with the step of forming the body of the pouch. Each pouch 10 has a predetermined shape, which in this example is a rectangle. The body of the pouch is formed from a roll of a preprinted laminate material, as previously described. In this example, the laminate material contains three layers.

One layer of the material is preferably preprinted with information or locating indicia (not shown), such as a registration mark. The registration marks are located on the material to denote an edge of a panel. The registration marks are read by an optical reading device (not shown), such as a scanner, to index the material in a predetermined position at the cutting station. The preprinted information may include labeling information that describes the product contained within the pouch. In this example, the layer of preprinted information is located on an outer layer of the material.

Various techniques may be utilized to form the body portion of the pouch, depending on the desired end shape of the pouch. The pouch may be formed from one sheet of material or two sheets. An example of a pouch forming machine is the Nishibe model number SBM500, SBM600 or SBM700. Preferably, several pouches are formed from one width of material. The material is removed from the roll, and may be cut into sections that are positioned to form the front panel and rear panel. The methodology advances to block 105.

In block 105, the valve 20 is inserted into one of the panels, such as the front wall panel. Various techniques are contemplated for insertion of the valve 20. For example, a valve aperture may be cut into the panel, and the valve is inserted into the aperture in the panel. The valve is welded to the panel, such as using a heat weld or and ultrasonic seal, to obtain an airtight seal around the valve. As previously described, the valve 20 provides for the venting of gas formed in the pouch 10, such as occurring by heating or cooling. It also allows for the transmission of oxygen or carbon dioxide. The valve 20 may be placed anywhere on the panel, such as in an upper corner of the pouch. It should be appreciated that an aperture 96 for the breathable patch 92, if present, may be punctured at the same time as the valve aperture. The patch 92 is then applied over the patch aperture 96, such as using the previously described adhesive. The methodology advances to block 110.

In block 110, other features are added to the pouch 10. For example, a gusset or insert may be positioned between the sidewalls of the pouch. Alternatively, the gusset or pleat is formed in the panel using a folding operation. In another example of a pouch with one seam, a fold is formed along an edge in the sheet of material. An example of this type of pouch is disclosed in commonly assigned U.S. Patent Application Ser. No. 60/598,394, which is incorporated herein by reference.

An opening means 26, may be applied in this step. The opening means 26 may be located on the pouch 10 in a variety of locations, such as mounted on a bottom, or a top, or a side portion of the pouch. Various types of opening means are contemplated, as previously described.

In block 115, the edges of the panel are sealed together. It is contemplated that the side edges, a lower edge, or a center edge may be sealed, depending on the configuration of the pouch. Various techniques are known in the art for sealing the edges together. An example of a method for sealing the edges of the pouch is described in commonly assigned U.S. patent application Ser. No. 11/195,906, which is incorporated herein by reference. For example, a heat weld process includes the application of heat and compression in a two-step welding operation. Another type of seal is an ultrasonic seal. One edge of the pouch may be left open, in order to fill the pouch. Alternatively, the pouch may be filled through the fitment. The methodology advances to block 120.

In block 120, a frangible seal 25, if present, is formed in the pouch panel. The frangible seal 25 may be selectively positioned to prevent a food product from contaminating the valve 20, as previously described. The location and shape of the seal 25 is determinable based on factors such as the location of the valve 20, the shape of the pouch 10, or the use of the pouch or the product contained therein. The frangible seal 25 may be formed using an ultrasonic sealing process or a thermosealing process that includes in the application of heat, such as a heat weld. Preferably, the frangible seal 25 is formed at a low temperature and pressure so that the seal has a predetermined burst temperature or pressure. The burst temperature or pressure of the frangible seal 25 is generally determined by the type of food product contained therein.

The methodology advances to block 125 and the pouches 10 are separated into individual pouches along a cutting line. The material is cut into a pouch 10 using a known cutting apparatus, such as a laser or punch or the like. The cutting apparatus imparts a single cut in the material to separate the pouches. The length of the pouch 10 is controlled by the distance between the cuts.

Alternatively, two pouches are cut out at one time from the roll of material, by adding a double cut between two cuts, preferably in the center. Advantageously, forming two pouches during the cutting operation effectively doubles the assembly line speed. It should be appreciated that the upper edge or lower edge may be further trimmed, such as to accommodate a fitment, or obtain a predetermined final pouch shape. An example is described in commonly assigned U.S. Patent Application Ser. No. 60/695,394, which is incorporated herein by reference.

The methodology advances to block 130, and the pouch is finished. For example, an edge of the pouch may be trimmed to a predetermined shape or hanger hole may be cut. This operation may be performed using a cutter or die cut or punch or the like. In another example, a crease or guide pocket 27 may be formed in a top portion of each wall in a creasing operation in order to facilitate opening and filling the pouch. A forming technique, such as stamping, may be utilized. Another example of a forming technique is the use of heated tubes that thermoform a crease 27 in each wall. An example of a method of forming a crease in a wall to facilitate opening the pouch is disclosed in commonly assigned patent application Ser. No. 10/310,221, which is incorporated herein by reference. In still another example, a sleeve may be applied over the individual pouch and shrunk to fit such as by using an application of heat to the pouch.

The methodology advances to block 135, and the finished pouches 10 are loaded off the machine. A transfer device such as a robot may be utilized. The finished pouch may be placed into a carrier that aligns the pouches in a predetermined position for transport to a filling machine, or directly transported to the filling line. The carrier may be a box, a magazine, or vacuum belt or the like for transporting a quantity of pouches. The methodology advances to block 140.

In block 140 the pouches are loaded onto a fill-seal machine. Advantageously, the fill-seal machine can be integral with the pouch forming machine, or a separate machine. This portability increases the flexibility of the pouch and may result in a manufacturing cost savings. An example is described in commonly assigned U.S. Pat. No. 6,837,535, which is incorporated herein by reference.

In block 145, the pre-made pouch 10 is then unloaded from the carrier and placed into a holder for moving the pouch between stations. The pre-made pouch may be lifted and placed using a robotic means, such as a pick and place mechanism. An example of a holder is a cup-shaped member, as disclosed in commonly assigned U.S. patent application Ser. No. 10/336,601, which is incorporated herein by reference. Alternatively, the pouch 10 may be held with grippers (not shown) as is known in the art. The methodology advances to block 150.

In block 150, the pouch 10 is opened in an opening operation. Various techniques are conventionally known in the art for opening the pouch 10. For example, the guide pocket 27 formed by the crease in the front wall panel 14 and rear wall panel 22 facilitates opening of the pouch. A nozzle (not shown) may be mechanically lowered into the guide pocket 27 to direct a stream of compressed gas into the guide pocket 27, to force the walls of the pouch 10 away from each other. An example of a gas is carbon dioxide or nitrogen having a plurality of apertures or the like. The blowing station may include a manifold (not shown), with a hood extending over the top of the upper edges 18 of the pouch 10. The hood is placed over the pouch 10 to assist in maintaining the air pressure in the pouch 10. The supply of pressurized gas is directed through the apertures to form a plurality of jets of pressurized gas or air. The jets are directed downwardly at the diamond-shaped openings formed at the upper edges 18 to assist in overcoming the surface tension of the pouch and assist in separation of the walls 14, 22. A diving rod (not shown) may then be used to make sure the pouch 10 is fully opened. If the pouch has a fitment, the gas is injected through the fitment. After the pouch is opened, it may be injected with super-saturated steam to eliminate any pathogens or the like. The methodology advances to block 155.

In block 155, the pouch 10 is filled with the prepared product in a filling operation. For example, a fill tube is lowered into the opened pouch 10 and the product is dispensed into the open pouch 10. The product is preferably dispensed at a predetermined temperature. The temperature may be dependent on the type of product. In the case of larger pouches or multi-compartment pouches, it may be necessary to move the pouches to a second fill station to complete the filling of the pouch. It should be appreciated that if the pouch contains more that one section for different food products, each food product is dispensed into the corresponding section.

The pouches 10 may be moved to a station where any oxygen in the pouch residing above the product is removed, if necessary. This can be accomplished such as by providing a hood or diving nozzle, whereby the oxygen is either evacuated or displaced with carbon dioxide or nitrogen. A diving nozzle may be used to inject the gas.

If the product is naturally carbonated, such as beer or soda or the like, the pouch is preferably filled while immersed in a nitrogen atmosphere. If the product is not naturally carbonated, it may be immersed in a carbonator to introduce carbon dioxide into the product, such as carbonator or the like. For example, carbon dioxide is introduced into a water or juice product to provide a carbonated beverage. The product may contain a mixture of up to four volumes of carbon dioxide. It should be appreciated that the carbon dioxide masks any undesirable taste from ketones or other solvents released during the sealing process. The carbon dioxide also increases the pressure within the product so that the walls of the pouch are rigid after the top is sealed. The pouch may be filled at a temperature ranging from 29° F. to ambient temperature. The methodology advances to block 160.

In block 160, the filled pouch is sealed. For example, if the pouch is filled through an open edge, the upper edge 16 of the pouch is closed by applying a closing seal 42a. In this example, the pouch is closed by sealing the open edges together using a heat weld, or an ultrasonic seal or an ultra pulse seal or the like. If the pouch holds a carbonated beverage, the pouch may be sealed as described in commonly owned PCT Patent Application No. PCT/US03/034396 which is incorporated herein by reference. If the pouch is a multi-compartment pouch, the other compartments are also sealed using the closing seal 42a.

In block 160, a second seal 42b may be applied above the first seal 42a for a carbonated product. The second seal may be a heat weld. Some of the product may be trapped between the first and second seals 42a, 42b. This is advantageous since there is no gas in the head space, i.e. the region between the product and the heat seal, and less pouch material is required. The second seal 42b may be a cosmetic seal applied above or over the first closing seal. In an example, the first closing seal 42a is a tack seal, and the second closing seal 42b is a high pressure, high temperature seal.

Alternatively, the pouch is filled through the spout fitment and the cap is applied to close the pouch. The cap may be a tamper-evident cap for a carbonated product, as previously described. The cap contains the product in the filled pouch, to prevent leakage of the product from the pouch. The complementary arrangement of threads and grooves in the cap and spout provides for the controlled release of pressure from the pouch.

In block 165, the filled pouch 10 is finished in a finishing operation. For example, the filled pouch may be cooled at a cooling station using a conventionally known cooling technique. The edges may be trimmed so that the pouch has a predetermined shape. Optionally, the sleeve may be placed over the filled pouch and shrunk to fit over the pouch by applying heat. The layer forms an outer layer of the pouch. The methodology advances to block 170.

In block 170, the filled pouch 10 is discharged from the machine. For example, the pouches are moved to a discharge station where the receptacles are moved from the arm of the turret outwardly onto the conveyor. The receptacles are then moved by the conveyor under robotic arms having grippers which are then lowered to grab the pouch 10 and lift the pouch 10 from the receptacles. The receptacles are then moved by the conveyor through a rinsing station and returned to the other side of the turret for use. The pouches 10 are placed into cartons using a transfer device, such as grippers or a robot or the like. At this point, the filled pouch is available for distribution. Alternatively, the filled pouch 10 may be placed onto another conveyor belt for additional processing, such as tunnel pasteurization for shelf stabilization, or freezing. In use, the unopened pouch may be heated and then separated into compartments, and each compartment is opened for accessing the contents contained therein.

It should be appreciated that the methodology may include other steps, such as an upstream oxygen purging station, downstream oxygen purging station, pasteurization, or the like. In addition, a manufacturing station may perform one or a plurality of operations, to enhance the efficiency of the methodology and apparatus. It is also contemplated that the order of implementing the steps may vary to facilitate the manufacturing process.

As shown in FIG. 7, another embodiment of a package 60 with a multi-purpose valve 20 is illustrated. The package includes a lower portion that is a tray 62, and a removable upper portion, that is a heat sealable/peelable film cover 64. The film cover 64 includes a multi-purpose valve 20, as previously described. The membrane element 230 in the valve assembly allows for the flow of gas into and out of the package at a predetermined respiration rate, as previously described. The film cover may also include a breathable patch 92, as previously described. The tray is filled with a portion of food and sealed. The tray 62 may be produced from a plastic such as cast polypropylene. The tray 62 has a bottom 66 and a side 70 having a top edge 72. The tray should remain stable to −72° Celsius. The tray 62 may have a variety of shapes, such as an oval shape. The tray may include integrally formed ribs 74 in the side 70 to provide strength to the tray. The tray may include an integrally formed handle 76 at each end to facilitate use of the tray 62.

The cover 64 is formed from a laminate material. For example, the laminate material includes a polyester layer, a polypropylene layer, and an adhesive layer. The polyester layer of this example has a thickness of 12.0 micrometers and a weight of 16.8 grams/m². The polypropylene layer of this example has a thickness of 90.0 micrometers and a weight of 81.0 grams/m². The adhesive layer of this example has a thickness of 2.5 micrometers and a weight of 2.5 grams/m². The film laminate preferably has a low oxygen permeability and water vapor permeability. In this example, the sealing medium of the adhesive layer has a melting point of 165° Celsius and a sealing range of 180°-230° Celsius, depending upon sealing time and pressure. An example of an adhesive layer is a mixture of a cast polypropylene and polyethylene. The film should be able to withstand a minimum amount of heat, such as a temperature of 120° Celsius. An example of this type of film is available from WIPF of Volketswll, Switzerland.

The film is supplied as a web. The web is unrolled and apertures are formed in the web at predetermined spaced apart locations. A multi-purpose valve 20 having a microporous membrane is applied to the film over the aperture formed in the web, such as by a heat weld. The previously described breathable patch 92 may be applied over another aperture in the cover 64. The portion of food 12 is filled into the tray 62 and the trays 62, and then delivered to a sealing station, where the web of film is then sealed on the edge 72 of the tray and cut to the shape of the tray 62. After heating, the cover may be peeled from the tray and the food is served in the tray.

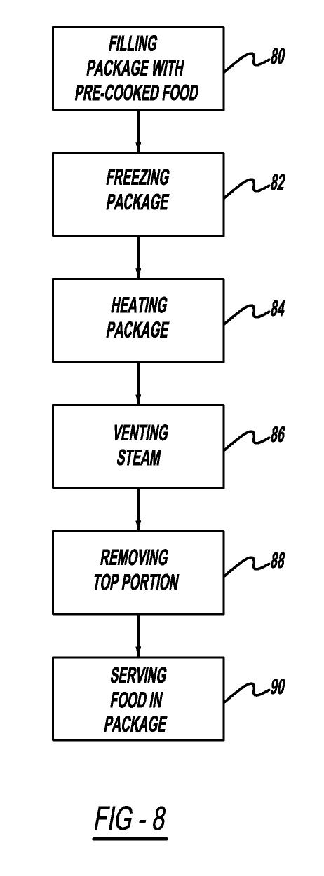

Referring to FIG. 8, a method of use of any of the packages is illustrated. In this example, a portion of precooked food having a moisture content which is generally 20% is dispensed into a package. The food portion can be a single food item or can be a dish prepared to a recipe. The precooking prevents rapid decomposition of the food. Thus, food which has been at least partially precooked may have a shelf life of about seventeen days. Fresh food may have a shelf life of approximately seven days, although the respiration of gases such as oxygen and carbon dioxide through the package may extend the shelf life of the product. In the precooked or blanched state, the food is cooked until it reaches a temperature of 125° Celsius. Satisfactory temperature ranges for partially cooked food are set forth as follows:

| | Temperature |
|---|---|
| Food | Celsius |
| Chicken | 125 |
| Beef | 130 |
| Fish | 110 |
| Pork | 125 |
| Green beans | 105 |
| Carrots | 105 |
| Broccoli | 100 |

Examples of satisfactory recipes are set forth below.

### Example 1

### Seared Chicken and Rice with Vegetables

| AMOUNT | INGREDIENT | NOTES |
|---|---|---|
| 135 g. | 90% cooked rice | Parboiled long |
| | | grain rice |
| 40 g. | Blanched broccoli florets, small | Blanched in |
| | | salted water |
| 25 g. | ¼ inch sliced and seared button | Seared in canola oil |
| | mushrooms | |
| 25 g. | ¼ inch sliced, blanched and half | Blanched |
| | moon cut carrots | in salted water |
| 10 g. | Prepared chicken stock | Prepared from chicken |
| | | base paste and water |
| 120 g. | Seared and ¼ inch slight | Seasoned with kosher |
| | bias-sliced chicken breast | salt and fresh ground |
| | | black pepper; seared |
| | | quickly on both sides. |
| | | Trimmed of all fat |
| | | and cartilage. |
| | | Seared in canola oil |
| 355 g. | | |

| | METHOD |
|---|---|
| 1. | Place rice, vegetables and chicken stock in base of container |
| 2. | Place chicken, slightly shingled, in one line across top of rice and |
| | vegetables |
| 3. | Place top on container and seal |
| 4. | Microwave at 800 watts for 4 minutes or until chicken is just cooked |
| | through |

### Example 2

### Penne Pasta Primavera with Seared Chicken

| AMOUNT | INGREDIENT | NOTES |
|---|---|---|
| 125 g. | 90% cooked penne or farfalle pasta | Cooked in |
| | | salted water. Real |
| | | Torino brand, |
| | | 100% durum semolina |
| 30 g. | Blanched broccoli florets, small | Blanched in |
| | | salted water |
| 25 g. | ¼ inch sliced and seared button | Seared in canola oil |
| | mushrooms | |
| 25 g. | ¼ inch sliced, blanched and half | Blanched in |
| | moon cut carrots | salted water |
| 20 g. | Frozen peas | |
| 60 g. | Prepared Alfredo sauce | Digiorno brand |
| 10 g. | Prepared chicken stock | Prepared from |
| | | chicken base |
| | | paste and water |
| 100 g. | Seared and ¼ inch straight sliced | Seasoned with |
| | chicken breast | kosher salt and |
| | | fresh ground |
| | | black pepper; |
| | | seared quickly |
| | | on both sides. |
| | | Trimmed of all fat |
| | | and cartilage. |
| | | Seared in canola oil |
| 395 g. | | |

| | METHOD |
|---|---|
| 1. | Combine pasta with vegetables and Alfredo sauce and toss to |
| | coat well. |
| | Place entire contents in base of container |
| 2. | Top with chicken slices in a single layer |
| 3. | Place top on container and seal |
| 4. | Microwave at 800 watts for 3 minutes 30 seconds, or until chicken is |
| | just cooked through |

If the food product has been precooked, it is available for packaging. The total volume of the food must not exceed 500 grams for a container having a volume of 700 grams. It should be appreciated that the food in the package may be processed, such as in a freezing step 82, where the food in the package is then flash frozen and stored until meal time. In this example, the valve device may be of the type which respires during the freezing. If desired, the valve may be covered with a seal which is removed before cooking.

In step 84, the filled package may be then heated as required for the recipe, such as using a microwave oven at a predetermined power level and time. In step 86, as the food portion is being heated, steam is vented from the package. The valve device 20 opens when the pressure within the pouch exceeds a predetermined pressure, such as 3 mbar and remains fully open throughout the heating process. In step 88, the user separates the pouch compartments along the line of weakening, if pressed. The user may open up each compartment to access the food product contained therein. In step 90, the user serves the product from the package. For example, the product can be served directly from the package. The product can be placed in the bowl 38 formed from the lower compartment, as shown in FIG. 4. The products in each compartment may be mixed together, or kept separate.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

1. A flexible pouch for packaging a product contained therein, the pouch comprising:
a panel of flexible material forming a body of the pouch; and
a multi-purpose valve assembly disposed in the panel, wherein the valve assembly includes:
a tubular body having an open end and a closed end that defines a recess between the open and closed ends, and the closed end includes an aperture for venting a pressurized gas therethrough,
a retaining member operative for snap-fit engagement with the tubular body that is spaced apart from the closed end of the tubular body,
a breathable membrane element having a plurality of apertures that is positioned between the closed end of the tubular body and the retaining member, such that the breathable membrane element is positioned adjacent the closed end for respiring a gas from the product through the plurality of apertures in the membrane element at a predetermined transmission rate, to maintain a predetermined concentration of oxygen and a predetermined concentration of carbon dioxide within the pouch during storage of the pouch.

2. The flexible pouch of claim 1, wherein the membrane element is displaceable from the closed end to vent a pressurized gas through the closed end aperture during heating of the pouch above a predetermined threshold temperature.

3. The flexible pouch as set forth claim 1 wherein the membrane element is a polypropylene material having a predetermined number of apertures of a predetermined size, to control the transmission rate of gas from the product during storage.

4. The flexible pouch as set forth claim 1 wherein the membrane element is a cast polypropylene material having a predetermined number of apertures of a predetermined size, to control the transmission rate of gas from the product during storage.

5. The flexible pouch of claim 1, wherein the pouch includes multiple compartments.

6. A multi-purpose valve assembly for maintaining a predetermined concentration of oxygen and a predetermined concentration of carbon dioxide during storage of a food product within an enclosed package, said multipurpose valve assembly comprising:
a tubular body having an open end and a closed end that defines a recess between the open and closed ends, and the closed end includes an aperture for venting pressurized gas therethrough;
a retaining member operative for snap-fit engagement with the tubular body that is spaced apart from the closed end of the tubular body; and
a breathable membrane element having a plurality of apertures that is positioned between the closed end of the tubular body and the retaining member, such that the breathable membrane element is positioned adjacent the closed end for respiring a gas from the product through the plurality of apertures in the membrane element at a predetermined transmission rate, to maintain a predetermined a concentration of oxygen and a predetermined concentration of carbon dioxide in the package during storage of the package, and the membrane element is displaceable from the closed end to vent a pressurized gas through the closed end aperture in the closed end during heating of the pouch above a predetermined threshold temperature.

7. The valve assembly as set forth in claim 6, wherein the tubular body includes a flanged portion defined along the open end thereof.

8. The valve assembly as set forth in claim 7, wherein the tubular body includes a rim formed along at least a portion of the flanged portion and operative for snap-fit engagement with the retaining member.

9. The valve assembly as set forth in claim 8, wherein the flanged portion includes an inside edge, the rim being formed along the inside edge.

10. The valve assembly as set forth in claim 9, wherein the tubular body is cylindrically shaped and the membrane element is sized corresponding to the diameter of the recess.

11. The valve assembly as set forth in claim 6, wherein the membrane element is a polypropylene material having a predetermined number of apertures of a predetermined size, to control the transmission rate of gas from the product during storage.

12. The valve assembly as set forth in claim 6 wherein the membrane element is a cast polypropylene material having a predetermined number of apertures of a predetermined size, to control the transmission rate of gas from the product during storage.

13. The valve assembly as set forth in claim 6, wherein the closed end includes a plurality of apertures.

14. The valve assembly as set forth in claim 13, wherein each of the plurality of apertures has a substantially sector shape with a diameter of 1.8 mm and a length of 2.6 mm.

15. A heatable package for a food product comprising:
a container for the food product having an open end;
a cover for the container that is a sealing film, wherein said cover is sealed the container to enclose the open end of the container;
a multi-purpose valve assembly disposed within the cover, wherein the valve assembly includes:
a tubular body having an open end and a closed end that defines a recess between the open and closed ends, and the closed end includes an aperture for venting a pressurized gas therethrough,
a retaining member operative for snap-fit engagement with the tubular body that is spaced apart from the closed end of the tubular body,
a breathable membrane element having a plurality of apertures that is positioned between the closed end of the tubular body and the retaining member, such that the breathable membrane element is positioned adjacent the closed end for respiring a gas from the product through the plurality of apertures in the membrane element at a predetermined transmission rate, to maintain a predetermined a concentration of oxygen and a predetermined concentration of carbon dioxide in the package during storage.

16. The package as set forth in claim 15, wherein the membrane element is displaceable from the closed end to vent a pressurized gas through the closed end aperture during heating of the package above a predetermined threshold temperature.

17. The package as set forth in claim 15, wherein the membrane element is a polypropylene material having a predetermined number of apertures of a predetermined size to control the transmission rate of gas from the product during storage.

18. The flexible as set forth in claim 15 wherein the membrane element is a cast polypropylene material having a predetermined number of apertures of a predetermined size, to control the transmission rate of gas from the product during storage.

19. The package as set forth in claim 15, wherein the closed end includes four apertures, and each aperture has a substantially sector shape with a diameter of 1.8 mm and a length of 2.6 mm.
